(19) United States
(12) Patent Application Publication
(10) Pub. No.: US 2004/0179136 A1
(43) Pub. Date: Sep. 16, 2004

(54) Image transmission system and method thereof

(76) Inventor: Chang-Hung Lee, Dounan Township (TW)

Correspondence Address: RABIN & BERDO, P.C., Suite 500, 1101 14th Street, N.W., Washington, DC, 20005, US

(21) Appl. No.: 10/794,086

(22) Filed: Mar. 8, 2004

(30) Foreign Application Priority Data
Mar. 11, 2003 (TW) 92105278

(51) Int. Cl. H04N 7/12; H04B 1/66

(52) U.S. Cl. 348/390.1; 375/240.01

(57) ABSTRACT

An image transmission system and method thereof is disclosed. A first frame converting unit is used for receiving a first video signal and removing redundant video fields to obtain a second video signal. A MPEG encoder is used for encoding the second video signal to obtain a third video signal, which is then converted to a transmission signal and is transmitted by a signal transmitter. A signal receiver is used for converting the transmission signal to a fourth video signal. A MPEG decoder is used for decoding the fourth video signal to obtain a fifth video signal. A second frame converting unit is used for generating redundant video fields by reproducing part of the video fields of the fifth video signal and adding the redundant video fields to the fifth video signal to obtain a sixth video signal. The sixth video signal is outputted to an image display to be displayed.

This application claims the benefit of Taiwan application No. 92105278, filed Mar. 11, 2003.

### BACKGROUND OF THE INVENTION

1. Field of the Invention

The invention relates in general to an image transmission system and method thereof, and more particularly to an image transmission system having an image transmitting device and an image receiving device and method thereof.

2. Description of the Related Art

Images can be delivered by a multi-media gateway through a wireless network, after the multi-media gateway receives video signals from a digital versatile disc (DVD) video display or from a TV system. These images can then be displayed by an image display device with a wireless receiving and decoding device.

Referring to FIG. 1, a block diagram of the multi-media gateway and the image display device with a wireless receiving and decoding device is shown. The multi-media gateway 100 consists of a Motion Picture Experts Group (MPEG) II encoder 102 and a signal transmitter (wireless transmitter)

104. The wireless receiving and decoding device 110 consists of a signal receiver (wireless receiver) 116 and a MPEG II decoder 118. When the MPEG II encoder 102 receives the video signal S via the audio-visual terminal (AV terminal), the video signal S is first processed using MPEG II encoding operation and is then input to the signal transmitter 104 to be converted to a transmission signal and outputted. The video signal S conforms to National Television Standards Committee (NTSC) standard.

As the signal receiver 116 receives the transmission signal transmitted from the signal transmitter 104, the transmission signal is converted to an electrical signal, which is input to the MPEG II decoder 118 to be decoded, and the original video signal S is recovered. Finally, the image display device 120 receives the video signal S and display the video signal S.

The NTSC-standard video signal S is transmitted at the rate of 60 video fields per second, and accordingly the signal transmitter 104 transmits data at the rate of 6-8 Mbps (Mega bit per second). However, the wireless communication protocol IEEE 802.11b defines the real data rate as 5 Mbps. Therefore wireless networks conforming to the IEEE 802.11b communication protocol cannot be used to transmit video data.

In order to solve the above problem, the MPEG IV encoder and MPEG IV decoder are applied to improve the efficiency of video signal compression, thus reducing the amount of data during wireless transmission. However, the Central Processing Unit (CPU) should perform more calculation and a higher performance CPU is needed, which results in increased costs.

Using the signal transmitter and signal receiver, which have broader bandwidth and are IEEE 802.11b communication protocol compliant, can also solve the problem. However, this method also increases cost.

Therefore, the main issue nowadays is how to efficiently decrease the data amount and calculation amount to satisfy the bandwidth requirement of wireless transmission without losing image quality.

### SUMMARY OF THE INVENTION

It is therefore an object of the invention to provide an image-transmission system and method thereof, which can efficiently reduce the transmission data amount and calculation amount to meet wireless transmission bandwidth requirements while providing high image quality.

According to one object of the invention, an image transmission system capable of transmitting a first video signal is disclosed, wherein the first video signal has R redundant video fields. The image transmission system includes an image transmitting device and an image receiving device. The image transmitting device includes a first frame converting unit, a motion picture encoder, and a signal transmitter. The image receiving device includes a signal receiver, a motion picture decoder, and a second frame converting unit. The first frame converting unit is used for receiving the first video signal and removing M redundant video fields to obtain a second video signal, M<=R. The motion picture encoder is used for encoding the second video signal so as to obtain a third video signal, so that the data amount of the third video signal is smaller than that of the second video signal. The signal transmitter is used for converting the third video signal to a transmission signal and for transmitting the transmission signal. The signal receiver is used for receiving the transmission signal and converting the transmission signal to a fourth video signal. The motion picture decoder is used for decoding the fourth video signal to obtain a fifth video signal. The second frame converting unit is used for generating the M redundant video fields by reproducing part of the video fields of the fifth video signal and add the M redundant video fields to the fifth video signal to obtain a sixth video signal. The sixth video signal and the first video signal have the same number of video fields.

According to another object of the invention, an image transmission method capable of transmitting a first video signal at an image transmitting device is disclosed, wherein the first video signal includes R redundant video fields. First, the first video signal is received, and a second video signal is obtained by removing M redundant video fields of the first video signal, M<=R. Then, the second video signal is encoded and thus a third video signal having a smaller data amount than the second video signal is obtained. Finally, the third video signal is converted to a transmission signal and is transmitted.

According to another object of the invention, an image transmission method for receiving a transmission signal at an image receiving device is disclosed. First, the transmission signal is received and is converted to a fourth video signal. Then, the fourth video signal is decoded to obtain a fifth video signal. Next, M redundant video fields of the fifth video signal are generated by reproducing part of the video fields of the fifth video signal and are added to the fifth video signal to obtain a sixth video signal. The sixth video signal includes R redundant video fields, M<=R.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of the multi-media gateway and the image display device with a wireless receiving and decoding device.

FIG. 2 shows the block diagram of the image transmission system according to a preferred embodiment of the invention.

FIG. 3 shows the relation of frames for film and the video field for the video signal when a pre 3:2 pulldown process and a post 3:2 pulldown process are performed respectively.

FIG. 4 shows the relation of the video fields while the first video signal is converted to the second video signal by the post 3:2 pulldown process, and while the fifth video fields is converted to the sixth video signal by the pre 3:2 pulldown process.

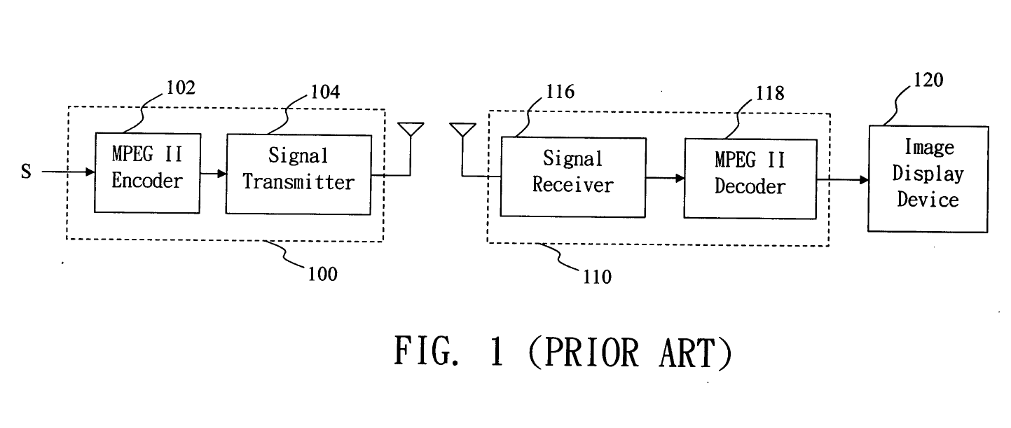

### DETAILED DESCRIPTION OF THE INVENTION

The invention includes the following steps to transmit a transmission signal to an image receiving device: removing the redundant video fields from a video signal, processing the MPEG II encoding, and converting the video signal to the transmission signal at the image transmitting device. At the image receiving device, the redundant video fields are reproduced and added to obtain the original video signal conforming to NTSC standard. The transmission data amount and calculation amount are reduced and maintain the same image quality.

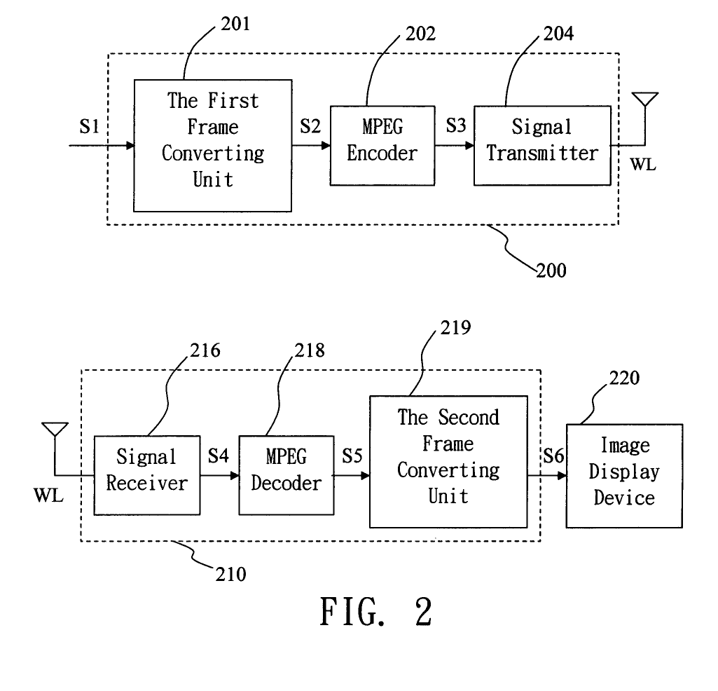

Referring to FIG. 2, a block diagram of the image transmission system according to a preferred embodiment of the invention is shown. The image transmission system includes an image transmitting device 200 and an image receiving device 210. The image transmitting device 200 includes a first frame converting unit 201, a MPEG encoder 202, and a signal transmitter 204. The image receiving device 210 includes a signal receiver 216, a MPEG decoder 218, and a second frame converting unit 219.

The first frame converting unit 201 receives a first video signal S1 in NTSC format. The first video signal S1 includes R redundant video fields, wherein R is an integral. M redundant video fields of the first video signal S1 are then removed by the first frame converting unit 201, wherein M is an integral and M<=R.

The MPEG encoder 202 encodes the second video signal S2 to obtain a third video signal S3. The data amount of the third video signal S3 is smaller than that of the second video signal S2. The third video signal S3 is then converted to a transmission signal WL by the signal transmitter 204 and the transmission signal WL is transmitted.

At the image receiving device, the signal receiver 216 receives the transmission signal WL and converts the transmission signal WL to a fourth video signal S4. MPEG decoder 218 then decodes the fourth video signal S4 to obtain a fifth video signal S5. The second frame converting unit 219 receives the fifth video signal S5 and outputs the sixth video signal S6 conforming to NTSC standard. By the second frame converting unit 219, M redundant video fields are generated by reproduced part of the video fields of the fifth video signal and M redundant video fields are added to the fifth video signal to obtain the sixth video signal S6. The sixth video signal S6 conforms to NTSC standard. Such that the sixth video signal S6 and the first video signal S1 have the same number of video fields. Finally, the image display device 220 receives the sixth video signal S6 and the image corresponding to the sixth video signal S6 is displayed.

If the image transmission system of the invention is applied in a wireless LAN system, the signal transmitter 204 will be a wireless signal transmitter 204 and the signal receiver 216 will be a wireless signal receiver. If the image transmission system of the invention is applied in a cable LAN system, the signal transmitter 204 and the signal receiver 216 will be omitted. The MPEG encoder 202 can be a MPEG II encoder, and the MPEG decoder 218 can be a MPEG II decoder.

To remove the redundant video fields from the first video signal S1, the post 3:2 pulldown process is performed on the first video signal S1 and, accordingly, the second video signal S2 is generated. To insert the redundant video field into the fifth video signal S5, the pre 3:2 pulldown process is performed on the fifth video signal S5 and, accordingly, the sixth video signal S6 is generated.

Herein, the first video signal S1 may have 30 frames per second, which corresponds to 60 video fields per second. The second video signal S2 may have 24 frames per second, which corresponds to 48 video fields per second, wherein R=M=12. The fifth video signal S5 and the sixth video signal S6 respectively may have 24 and 30 frames per second, corresponding to 48 and 60 video fields per second.

The pre 3:2 pulldown process is nowadays used in the image processing for converting the frame of the film to video signals conforming to NTSC standard. Films played in movie theaters have 24 frames per second. However, the video signal in NTSC format displayed on TV is at 60 video fields per second. Therefore, film running at 24 frames per second must go through a pre 3:2 pulldown process to be displayed on TV.

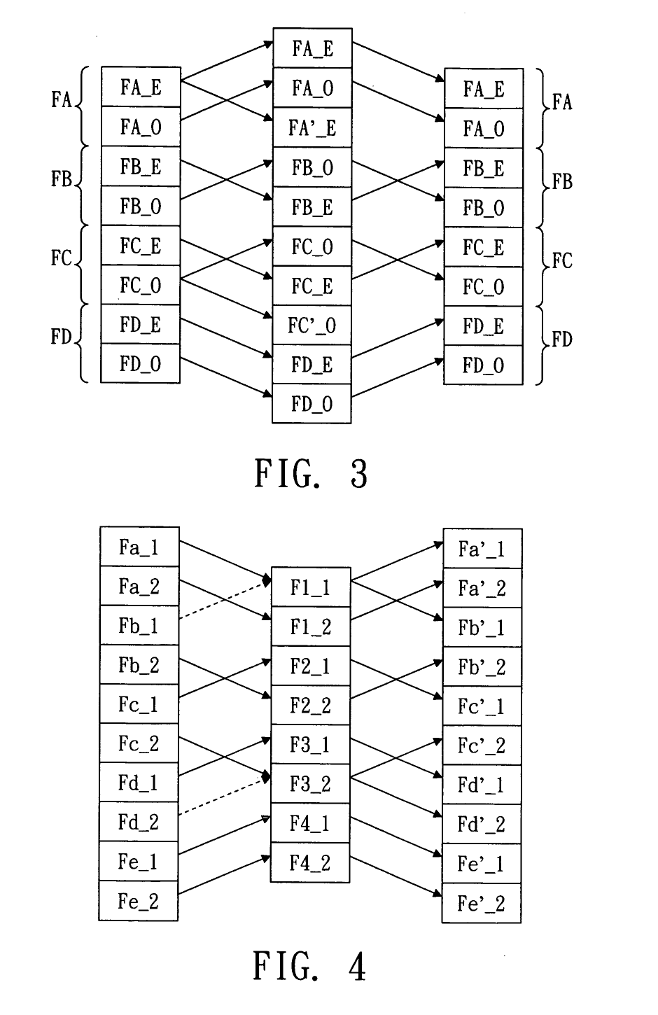

FIG. 3 shows the relation of frames for film and the video field for the video signal when a pre 3:2 pulldown process and the post 3:2 pulldown process are performed respectively. The film may have frames of FA, FB, FC, and FD. Each frame has an even video field and an odd video field, such as FA_E and FA_O. The even video field consists of the displayed lines of even number of the corresponding frame and the odd video field consists of the displayed lines of odd number of the corresponding frame.

The pre 3:2 pulldown process can convert 4 frames to 10 video fields such that the 4 frames, corresponding to 8 video fields of FA_E, FA_O, FB_E, FB_O FC_E, FC_O, FD_E, and FD_O, are converted to 10 video fields of FA_E, FA_O, FA′_E, FB_O, FB_E, FC_O, FC_E, FC′_O, FD_E, and FD_O. The resulting 10 video fields includes two redundant video fields of FA′_E and FC′_O, by which the film conforms to NTSC standard and can be displayed on the TV.

The post 3:2 pulldown process retrieves the original film of 24 frames by removing the added redundant video fields and rearranging the sequence of the video fields. For example, the post 3:2 pulldown process transfers the 10 video fields, being FA_E, FA_O, FA′_E, FB_O, FB_E, FC_O, FC_E, FC′_O, FD_E, and FD_O, to 8 video fields of FA_E, FA_O, FB_E, FBO, FC_E, FC_O, FD_E, and FD_O. The 8 video fields respectively correspond to 4 frames of FA, FB, FC, and FD.

FIG. 4 shows the relation of the video fields while the first video signal S1 is converted to the second video signal S2 by the post 3:2 pulldown process, and while the fifth video fields S5 is converted to the sixth video signal S6 by the pre 3:2 pulldown process. The first video signal S1 in NTSC format includes a number of redundant video fields. When the first video signal S1 is received by the first frame converting unit 201, the redundant video fields of the first video signal S1 are removed by the post 3:2 pulldown process. Then, the sequence of the video fields is rearranged and the second video signal S2 is generated. At the second frame converting unit 219, the redundant video fields are inserted into the fifth video signal S5. And the sixth video signal S6 is then generated from the second frame converting unit 219 by rearranging the sequence of the video fields.

As shown in FIG. 4, the first video signal S1 may include the video fields of Fa_1, Fa_2, Fb_1, Fb_2, Fc_1, Fc_2, Fd_1, Fd_2, Fe_1, and Fe_2. The second video signal S2 may include the video fields of F1_1, F1_2, F2_1, F2_2, F3_1, F3_2, F4_1, and F4_2, which respectively correspond to the video fields of Fa_1, Fa_2, Fc_1, Fb_2, Fd_1, Fc_2, Fe_1, and Fe_2. The redundant video fields of Fb_1 and Fd_2 are removed during the post 3:2 pulldown process.

Due to the redundant video fields of Fb_1 and Fd_2 are removed, the data amount of the second video signal S2 is effectively smaller than that of the first video signal S1, such that the calculation amount of the MPEG encoder 202, as well as the data amount of the wireless transmission, is efficiently reduced. The second video signal S2 retains all the video information of the frames of the first video signal S1 since the removed video fields of Fb_1 and Fd_2 are redundant video fields.

The fifth video signal S5 may include the video fields of F1_1, F1_2, F2_1, F2_2, F3_1, F3_2, F4_1, and F4_2. The six video signal S6 may include the video fields of Fa′_1, Fa′_2, Fb′_1, Fb′_2, Fc′_1, Fc′_2, Fd′_1, Fd′_2, Fe′_1, and Fe′_2, which respectively correspond to the video fields of F1_1, F1_2, F1_1, F2_2, F2_1, F3_2, F3_1, F3_2, F4_1, and F4_2. Please note that the video fields of Fb′_1 and Fd′_2 are redundant video fields. The added redundant video fields of Fb′_1 and Fd′_2 facilitate the NTSC formatting of the sixth video signal S6 as well as the displaying of the sixth video signal S6 on the image display device 220. Meanwhile, the second video signal S2, as well as the fifth video signal S5, has all the video information of the frame for the first video signal S1. Therefore, the sixth video signal S6, displayed on the image display device 220, has the preserved image quality of the first video signal S1.

The invention further provides a method for transmitting a first video signal S1 at the image transmitting device, wherein the first video signal S1 includes R redundant video fields. First, the first video signal S1 is received, and a second video signal S2 is obtained by removing M redundant video fields, M<=R. Then, the second video signal S2 is encoded and thus a third video signal S3 having a smaller data amount than the second video signal S2 is obtained. Finally, the third video signal S3 is converted to a transmission signal WL and is transmitted.

The invention further provides a transmission method for receiving a transmission signal at the image receiving device. First, the transmission signal is received and is converted to a fourth video signal S4. Then, the fourth video signal S4 is decoded to obtain a fifth video signal S5. Next, M redundant video fields are generated by reproducing part of the fifth video signal S5 and the M redundant video fields are added to the fifth video signal S5 to obtain the sixth video signal S6. The sixth video signal S6 includes R redundant video fields, M<=R.

The image transmission system and method thereof in the invention can efficiently reduce the transmission data amount and calculation amount to meet wireless transmission bandwidth requirements. In addition, the invention can provide a high quality image.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image transmission system capable of transmitting a first video signal, the first video signal having R redundant video fields, the image transmission system comprising:
an image transmitting device comprising:
a first frame converting unit used for receiving the first video signal and removing M redundant video fields to obtain a second video signal, M<=R;
a motion picture encoder for processing the second video signal to obtain a third video signal, such that the data amount of the third video signal is smaller than that of the second video signal;
a signal transmitter used for converting the third video signal to a transmission signal and for transmitting the transmission signal; and an image receiving device comprising:
a signal receiver used for receiving the transmission signal and converting the transmission signal to a fourth video signal;
a motion picture decoder for processing the fourth video signal to obtain a fifth video signal; and
a second frame converting unit used for generating the M redundant video fields by reproducing part of the video fields of the fifth video signal and adding the M redundant video fields to the fifth video signal to obtain a sixth video signal, the sixth video signal and the first video signal having the same number of video fields.

2. The image transmission system according to claim 1, wherein the redundant video fields of the first video signal are removed by the post 3:2 pulldown process to obtain the second video signal.

3. The image transmission system according to claim 2, wherein the M redundant video fields are inserted into the fifth video signal by the pre 3:2 pulldown process to obtain the sixth video signal.

4. The image transmission system according to claim 3, wherein the first video signal conforms to NTSC standard and has 30 frames per second corresponding to 60 video fields per second, and the second video signal has 24 frames per second corresponding to 48 video fields per second.

5. The image transmission system according to claim 4, wherein the fifth video signal has 24 frames per second corresponding to 48 video fields per second, the sixth video signal conforms to NTSC standard and has 30 frames per second corresponding to 60 video fields per second.

6. The image transmission system according to claim 1, wherein the motion picture encoder is an MPEG encoder and the motion picture decoder is an MPEG decoder.

7. An image transmitting device capable of transmitting a first video signal, the first video signal having R redundant video fields, the image transmitting device comprising:
a first frame converting unit used for receiving the first video signal and removing M redundant video fields from the first video signal to obtain a second video signal, M<=R;
a motion picture encoder for processing the second video signal to obtain a third video signal, such that the data amount of the third video signal is smaller than that of the second video signal; and
a signal transmitter used for converting the third video signal to a transmission signal and for transmitting the transmission signal.

8. The image transmitting device according to claim 7, wherein the redundant video fields are removed from the first video signal by the post 3:2 pulldown process to obtain the second video signal.

9. The image transmitting device according to claim 7, wherein the first video signal conforms to NTSC standard and has 30 frames per second corresponding to 60 video fields per second, and the second video signal has 24 frames per second corresponding to 48 video fields per second.

10. The image transmitting device according to claim 7, wherein the motion picture encoder is an MPEG encoder.

11. An image receiving device comprising:
a signal receiver used for receiving a transmission signal and converting the transmission signal to a fourth video signal;
a motion picture decoder used for processing the fourth video signal with motion picture encoding to obtain a fifth video signal; and
a second frame converting unit for generating M redundant video fields by reproducing part of the video fields of the fifth video signal and adding the M redundant video fields to the fifth video signal to obtain a sixth video signal, the sixth video signal having R redundant video fields, M<=R.

12. The image receiving device according to claim 11, wherein the M redundant video fields are inserted into the fifth video signal by the pre 3:2 pulldown process to obtain the sixth video signal.

13. The image receiving device according to claim 11, wherein the fifth video signal has 24 frames per second corresponding to 48 video fields per second, and the sixth video signal conforms to NTSC standard and has 30 frames per second corresponding to 60 video fields per second.

14. The image receiving device according to claim 11, wherein the motion picture decoder is an MPEG decoder.

15. An image transmission method capable of transmitting a first video signal at an image transmitting device, the first video signal having R redundant video fields, the image transmission method comprising:
receiving the first video signal and removing M redundant video fields of the first video signal to obtain a second video signal, M<=R;
encoding the second video signal to obtain a third video signal, such that the data amount of the third video signal is smaller than that of the second video signal; and
converting the third video signal to a transmission signal and transmitting the transmission signal.

16. The image transmission method according to claim 15, wherein the M redundant video fields are removed from the first video signal by the post 3:2 pulldown process to obtain the second video signal is obtained.

17. The image transmission method according to claim 15, wherein the first video signal conforms to NTSC standard and has 30 frames per second corresponding to 60 video fields per second, and the second video signal has 24 frames per second corresponding to 48 video fields per second.

18. An image transmission method for receiving a transmission signal at an image receiving device, the image transmission method comprising:
receiving a transmission signal and converting the transmission signal to a fourth video signal;
decoding the fourth video signal to obtain a fifth video signal; and
generating M redundant video fields by reproducing part of the video fields of the fifth video signal and adding the M redundant video fields to the fifth video signal to obtain a sixth video signal, the sixth video signal having R redundant video fields, M<=R.

19. The image transmission method according to claim 18, wherein the M redundant video fields are inserted into the fifth video signal by the pre 3:2 pulldown process to obtain the sixth video signal.

20. The image transmission method according to claim 18, wherein the fifth video signal has 24 frames per second corresponding to 48 video fields per second, and the sixth video signal conforms to NTSC standard and has 30 frames per second corresponding to 60 video fields per second.
